(19) United States
(12) Patent Application Publication
(10) Pub. No.: US 2003/0017862 A1
(43) Pub. Date: Jan. 23, 2003

(54) Method and system for calculating an associated fortune for two or more people

(75) Inventor: Jeong-yong Seong, Seoul (KR)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Sazoo.com Co., Ltd., Seoul (KR)

(21) Appl. No.: 10/197,785

(22) Filed: Jul. 18, 2002

(30) Foreign Application Priority Data
Jul. 20, 2001 (KR) 2001-43782

(51) Int. Cl. A63F 13/00; A63F 9/24; G06F 19/00

(52) U.S. Cl. 463/1

(57) ABSTRACT

A method and system for calculating an associated fortune for two or more people are provided. The method for calculating an associated fortune for two or more people involves: calculating a primary output signal by receiving a primary input at least one time from a primary user; calculating a secondary output signal by receiving a secondary input at least one time from at least one secondary user as the other party for their associated fortune; calculating a final output signal using the primary output signal and the secondary output signal; and obtaining output data including the content of a fortune corresponding to the final output signal. The associated fortune calculating method and system attracts users and improves user's trust in fortune telling service providers.

### BACKGROUND OF THE INVENTION

1. Field of the Invention

The present invention relates to a method and system for providing fortune telling, and more particularly, to a method and system for calculating an associated fortune for two or more users using input signals from the users.

2. Description of the Related Art

From ancient times, one's fortunes have been predicted based on the year, month, day, and hour (called “the Four Pillars”) of their birth, their name, their birth sign from the zodiac, etc. In addition, coins or rice have been used to predict one's fortunes by a fortuneteller with the predetermination of a type of fortune the one wishes to obtain.

In general, a consultant (or a fortuneteller) who is specialized in fortune-telling lore predicts one's fortunes through a one-on-one consultation with those who inquire about their fortune. However, recent advances in computer communications allow a common user to be provided with his/her fortune using the Internet or software installed in his/her personal computer, which provides a program storing those materials for fortune telling, without the need for a personal consultation.

One of the methods for predicting ones' fortunes using a computer is shown in FIG. 1. Initially, a user determines which type of fortune he/she wants to obtain and clicks on a “confirm” button displayed at the bottom right of the screen. The computer generates a random signal indicating “Yin” or “Yang” according to the time when the user clicks on the “confirm” button. A continuous line indicating the “Yang” or discontinuous lines indicating “Yin” are displayed depending on the signal generated upon receipt of a confirmation signal.

When the user clicks on the “confirm” button six times, six output lines corresponding to the input signals from the user are displayed as shown on the right of FIG. 1. The six lines, each of which represents “Yang” or “Yin”, provide 64 (=2⁶) different output results corresponding to 64 trigrams from the Book of Changes.

In the computer a database of fortunes for each of the 64 trigrams is established through software. The contents of a fortune corresponding to the output lines, which matches one of the 64 trigrams, are retrieved from the database according to the signal input by the user and displayed for the user. Through this procedure the user can be provided with his/her fortune of interest.

However, the above-described method is used for the fortune telling of only one person, not for an associated fortune of two or more people. An associated fortune of two or more people means one combined fortune determined by mutual influences, not each individual's independent fortunes. However, the above-described method fails to consider the mutual influences of those concerned.

As an example, if two people use software established based on the above-described method or access a web site which provides a fortune telling service based on the above-described method, to predict their fortune in love, there would be a conflict between the results obtained in response to requests by each person; one of the results may be a favorable fortune for love, but the other result may be an unfavorable fortune for love. These results lead to confusion on what exactly is their fortune in love and causes distrust in those service providers or software. Finally, clients or purchasers of the web sites providing a fortune telling service using the method or those software decrease.

### SUMMARY OF THE INVENTION

To solve the above-described problems, it is an object of the present invention to provide a method for calculating an associated fortune for two or more people.

It is another object of the present invention to provide a system for calculating an associated fortune for two or more people.

It is another object of the present invention to provide a computer readable recording medium having embodied thereon a computer program for the above method.

According to an aspect of the present invention, there is provided a method for calculating an associated fortune for two or more people, the method comprising: calculating a primary output signal by receiving a primary input for the associated fortune at least one time from a primary user; calculating a secondary output signal by receiving a secondary input at least one time from at least one secondary user as the other party for their associated fortune; calculating a final output signal using the primary output signal and the secondary output signal; and obtaining output data including the content of a fortune corresponding to the final output signal.

The present invention also provides a method for calculating an associated fortune for two or more people, the method comprising: calculating a primary output signal by receiving a primary input for the associated fortune from a primary user; receiving from the primary user the designation of at least one secondary user as the other party for their associated fortune; transmitting an associated fortune request to the at least one secondary user; receiving a secondary output signal calculated using a secondary input from the at least one secondary user; calculating a final output signal using the primary output signal and the secondary output signal; and obtaining output data including the contents of a fortune corresponding to the final output signal.

The present invention also provides a method for calculating an associated fortune for two or more people, the method comprising: calculating a primary output signal by receiving a primary input for the associated fortune from a primary user; receiving from the primary user the designation of at least one secondary user as the other party for their associated fortune; transmitting the primary output signal and an associated fortune request to the at least one secondary user; and receiving from the at least one secondary user output data including the contents of a fortune corresponding to a final output signal calculated using the primary output signal and a secondary output signal calculated using a secondary input from the at least one secondary user.

According to another aspect of the present invention, there is provided a system for calculating an associated fortune for two or more people, the system comprising: a first terminal including a first input unit which receives from a first user a first input for a first output signal and the designation of at least one second user as the other party for their associated fortune, a first transmission unit which transmits to a fortune provider server an associated fortune request to the designated at least one second user and the first input from the first user, and a first reception unit which receives the contents of a fortune from the fortune provider server; a second terminal including a second input unit which receives from the at least one second user a second input for a second output signal, a second reception unit which receives the associated fortune request and the contents of a fortune from the fortune provider server, and a second transmission unit which transmits the second input from the second user, and a server system including an output signal generator which calculates the first output signal from the first input and the second output signal from the second input and calculates a final output signal by altering the first output signal using the second output signal or by combining the first output signal with the second output signal, a database of a variety of fortunes from which the contents of a fortune corresponding to the final output signal is output, a search unit which searches the database for the contents of a fortune corresponding to the final output signal, and a third transmission unit which transmits the searched contents from the search unit to the first terminal and the second terminal.

The present invention also provides a system for calculating an associated fortune for two or more people, the system comprising: a first terminal including a first input unit which receives from a first user a first input for a first output signal and the designation of at least one second user as the other party for their associated fortune, a first output signal generator which generates a first output signal from the first input, a first transmission unit which transmits to a fortune provider server an associated fortune request to the designated at least one second user and the first output signal for the first user, and a first reception unit which receives the contents of a fortune from the fortune provider server; a second terminal including a second input unit which receives from the at least one second user a second input for a second output signal, a second output signal generator which generates a second output signal from the second input, a second reception unit which receives the associated fortune request and the contents of a fortune from the fortune provider server, and a second transmission unit which transmits the second output signal for the second user, and a server system including a final output signal generator which calculates a final output signal by altering the first output signal using the second output signal or by combining the first output signal with the second output signal, a database of a variety of fortunes from which the contents of a fortune corresponding to the final output signal is output, a search unit which searches the database for the contents of a fortune corresponding to the final output signal, and a third transmission unit which transmits the searched contents from the search unit to the first terminal and the second terminal.

The present invention also provides a system for calculating an associated fortune for two or more people, the system comprising: an input unit which receives from a first user input for an output signal and the designation of at least one second user as the other party for their associated fortune; an output signal generator which generates a first output signal using the input from the input unit; a first transmission unit which transmits a first associated fortune request to the at least one second user; a first reception unit which receives a second output signal generated using input from the at least one second user; a final output signal generator which generates a final output signal from the first output signal and the second output signal; a database of a variety of fortunes from which the contents of a fortune corresponding to the final output signal is output; and an output unit which outputs the contents of a fortune corresponding to the final output signal from the database.

The present invention also provides a system for calculating an associated fortune for two or more people, the system comprising: a reception unit which receives input from at least two users who wish to obtain their associated fortune; an output signal generator which generates an output signal using the input from the at least two users from the reception unit; a database of a variety of fortunes from which the contents of a fortune corresponding to the final output signal is output; a search unit which searches the database for the contents of a fortune corresponding to the output signal; and a transmission unit which transmits the search contents from the search unit to the at least two users.

According to another aspect of the present invention, there is provided a computer readable medium having embodied thereon a computer program for any one of the above-described methods for calculating an associated fortune for two or more people.

### BRIEF DESCRIPTION OF THE DRAWINGS

The above objects and advantages of the present invention will become more apparent by describing in detail preferred embodiments thereof with reference to the attached drawings in which:

FIG. 1 shows an example of a conventional method for calculating ones' fortune using a computer;

FIG. 2 is a schematic view of a system for calculating an associated fortune for two or more users according to a preferred embodiment of the present invention;

FIG. 3 is a block diagram of a user's terminal available to obtain an associated fortune for two or more users in connection with a server system;

FIG. 4 is a block diagram of a fortune provider server according to the present invention;

FIG. 5 is a block diagram of a first user's terminal and second user's terminal available to obtain an associated fortune for the users, without using the fortune provider server;

FIG. 6 is a flowchart illustrating a method for calculating an associated fortune for two or more users using the fortune provider server according to the present invention;

FIGS. 7 through 9 show examples of calculating a final output signal using a first output signal for a first user and a second output signal for a second user;

FIG. 10 is a flowchart illustrating another embodiment of the method for calculating an associated fortune for two or more users using a fortune provider server;

FIG. 11 shows a detailed embodiment of the method of FIG. 10 for calculating an associated fortune in love between two users;

FIG. 12 is a flowchart illustrating an embodiment of the method for calculating an associated fortune for two or more users without using a fortune provider server; and

FIG. 13 is a flowchart illustrating another embodiment of the method for calculating an associated fortune for two or more users without using a fortune provider server.

### DETAILED DESCRIPTION OF THE INVENTION

The present invention will be described in greater detail with reference to the accompanying drawings, in which preferred embodiments of the present invention are shown. This invention may, however, be embodied in many different forms without departing from the sprit and scope of the invention.

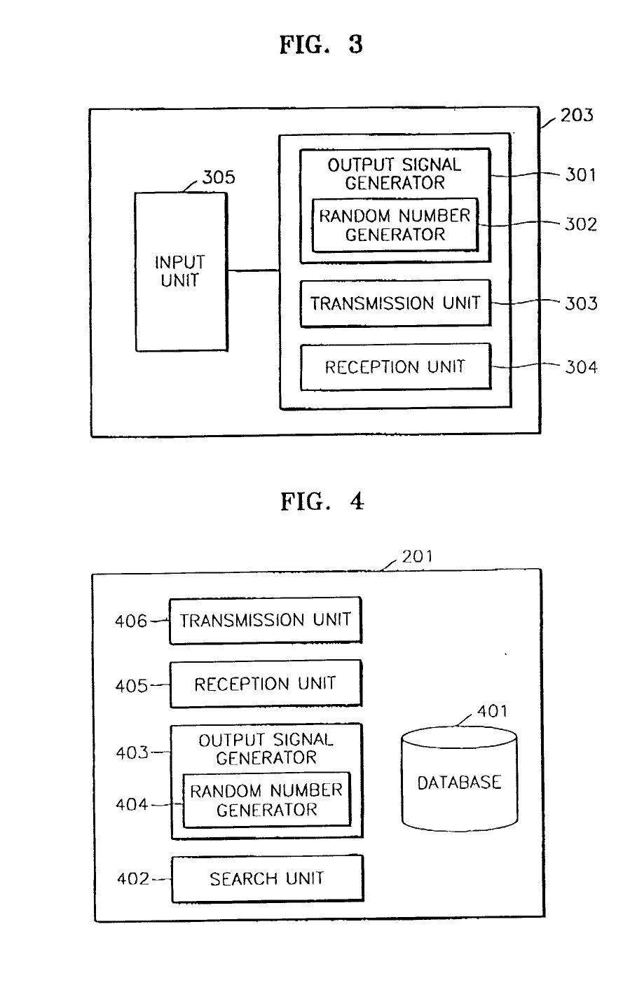

FIG. 2 is a schematic view of a system for calculating an associated fortune for two or more users according to a preferred embodiment of the present invention. Referring to FIG. 2, a fortune provider server 201 is a server system for providing a plurality of users, including a first user 203-1, a second user 203-2, . . . , and an n-th user 203-n, who access the server system through a network, with their fortune. The first user 203-1, the second user 203-2, . . . , and the n-th user 203-n can transmit an associated fortune request to another user via the fortune provider server 201. The network 202 of FIG. 2 may be a wired network, such as the Internet, or a wireless network based on mobile phones.

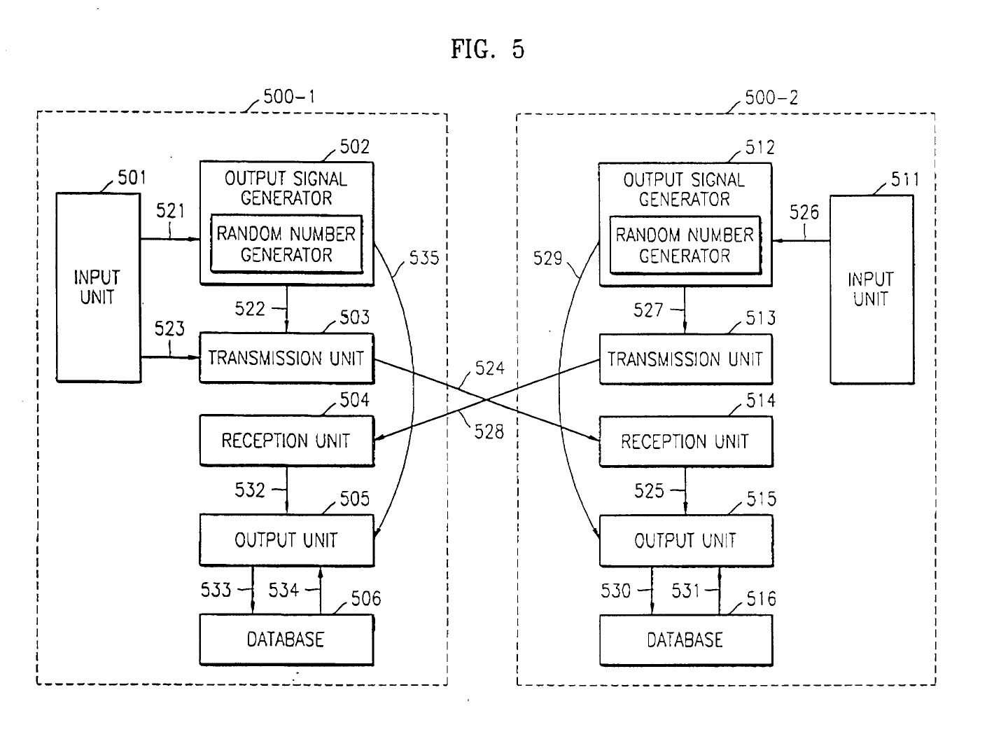

FIG. 3 is a block diagram of a user's terminal 203 available to obtain an associated fortune for two or more users in connection with the server system 201. An input unit 305 receives from the user input for an output signal used to calculate the associated fortune and the designation of another user as the other party for their associated fortune and transmits the received data through a transmission unit 303 to the fortune provider server 201. The input unit 305 receives a user's choice of categories of fortunes the user is interested in, for example, a fortune in love or business, and transmits the user's choice through the transmission unit 303 to the fortune provider server 201.

The user's terminal 203 calculates the output signal from the user's input as well as transmits the input from the user, and transmits the calculated output signal to the fortune provider server 201. To this end, the user's terminal 203 further comprises an output signal generator 301.

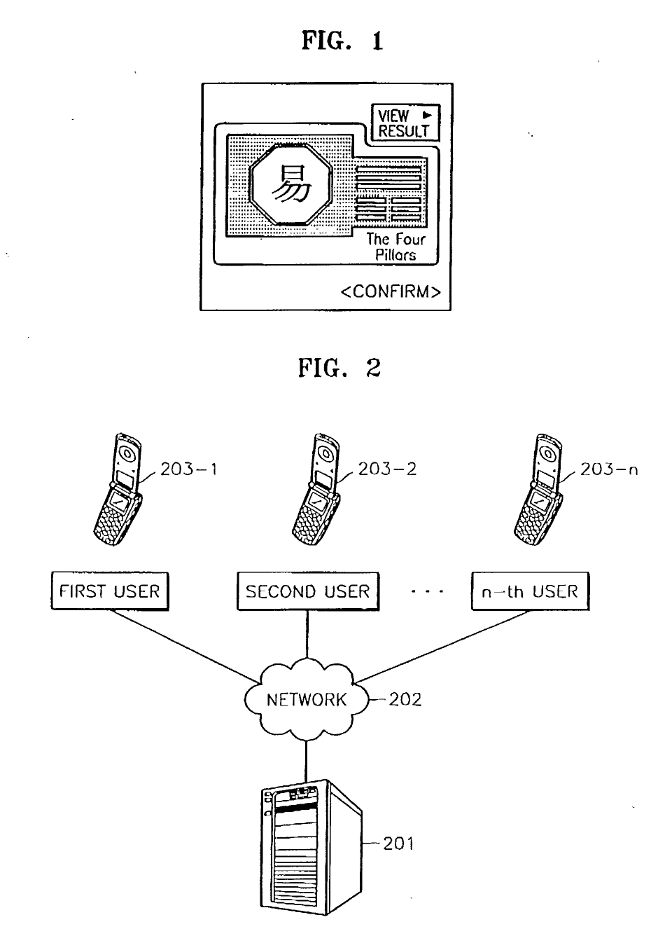

The output signal generator 201 includes a random number generator 301 which generates a random number indicating “Yin” or “Yang”. The output signal generator 301 generates the output signal by combining the random number generated by the random number generator 302 and the user's input received via the input unit 305. For example, in the conventional method described with reference to FIG. 1, the random number generator 302 randomly generates two kinds of signals, for example, 0 and 1, indicating “Yang” and “Yin”, respectively. One of those signals is output upon user's clicking on the “confirm” button.

To predict a user's fortune, a full set of output signals corresponding to one of the 64 trigrams, which are displayed as 6 output lines, is needed. To this end, the user has to click on the “confirm” button 6 times. However, if the random number generator 302 is constructed to generate 64 kinds of signals, a full set of output signals corresponding to one of the 63 trigrams can be obtained through clicking only once.

As described above, the number of times data should be input for a full set of output signals can be arbitrarily determined by a fortune telling service provider depending on the number of kinds of signals generated by the random number generator 302 and the number of categories of fortunes provided by the fortune provider server 201. For example, if the fortune provider server 201 provides 128 kinds of contents, the random number generator 302 may be constructed to generate 128 kinds of signals such that a full set of output signals is obtained through inputting data only once. Alternatively, a full set of output signals may be obtained through inputting data seven times with 2 kinds of signals generated by the random number generator 302. Alternatively, the random number generator 302 may be constructed to generate 64 kinds of signals upon first receipt of input data and 2 kinds of signals upon second receipt of input data such that a full set of output signals can be obtained through inputting data twice. Those structures associated with the number of times data is input for a full set of output signals may be varied.

A reception unit 304 receives an associated fortune request from another user, which has been transmitted via the fortune provider server 201, and informs the user of the terminal 203 of the reception of the request. The reception unit 304 receives data including the contents of a fortune calculated by the fortune provider server 201 using the output signals from two or more users, including the user of the terminal 203, and informs the user of the reception of the data.

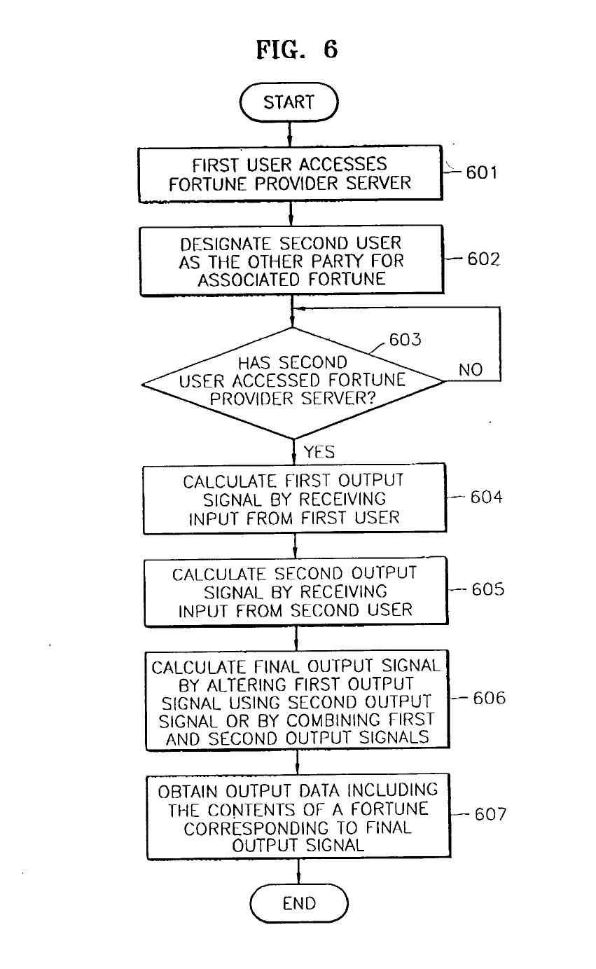

FIG. 4 is a block diagram of the fortune provider server 201. In a database 401, fortunes for each of the 64 trigrams of the Book of Changes are stored for each category of fortunes which are to be retrieved according to a final output signal calculated based on a user's interest in a particular category and using the output signals for the inputs from two or more users. Here, categories of fortunes include a fortune in love, a fortune in business, etc., as described above.

A reception unit 405 receives input from the terminal 203 of a user (hereinafter, a “first user”) who wishes to predict an associated fortune with someone and transmits the input to an output signal generator 403, or receives the output signal from the terminal 203 of the first user and transmits the output signal to the output signal generator 403. Also, the reception unit 405 receives an associated fortune request from the first user and transmits the associated fortune request via a transmission unit 406 to another user (hereinafter, a “second user”) designated by the first user as the other party for their associated fortune.

The transmission unit 406 transmits the associated fortune request received by the reception unit 405 to the second user designated by the first user and transmits a final output data including the contents of their associated fortune to both of the first and second users. The transmission, for example, of the associated fortune request by the transmission unit 406 may be achieved in a variety of ways, for example, via a short message service (SMS), an instant messenger, or an e-mail.

The output signal generator 403 calculates a final output signal using the signals received from the first and second users. When the input signals are received from a user because his/her terminal 203 does not include the output signal generator 301 shown in FIG. 3, the output signal generator 403 generates output signals for the input signals, as described with reference to FIG. 3, using arbitrary signals generated by a random number generator 404 included therein, calculates a final output signal from the output signals, and transmits the final output signal to a search unit 402.

When the output signals are received from the users because their terminal 203 includes the output signal generator 301, the output signal generator 301 calculates a final output signal using the output signals from the users and transmits the final output signal to the search unit 402.

The search unit 402 receives the final output signal from the output signal generator 403, searches the database 401 for the contents of a fortune corresponding to the final output signal, and transmits the searched contents to the users via the transmission unit 406.

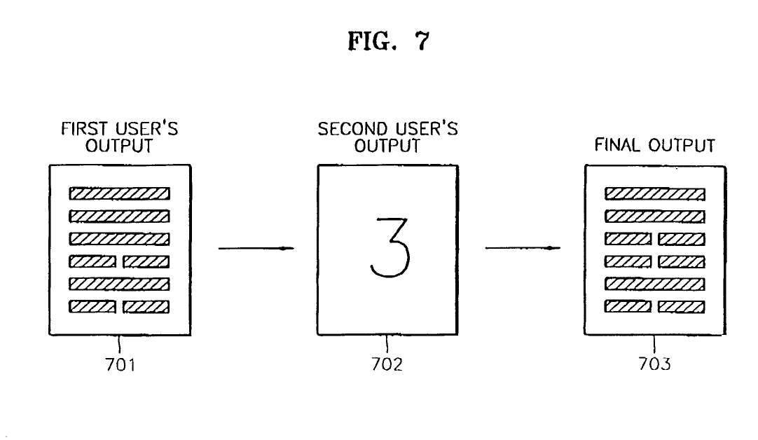

FIG. 5 is a block diagram of a first user's terminal 500-1 and second user's terminal 500-2 both of which have the function of the fortune provider server 201 to provide the users with their fortunes, without using the fortune provider server 202 described with reference to FIGS. 2 through 4.

The first user designates users as the other party for their associated fortune (herein assumed as the “second user”) and inputs an input signal for a first output signal to be used to calculate their fortune, by using an input unit 501. The input signal is transmitted to an output signal generator 502, as indicated by an arrow 521. The first output signal is generated by the output signal generator 502 and transmitted to a transmission unit 503.

The transmission unit 523 transmits, as indicated by an arrow 524, an associated fortune request by the first user and the first output signal to the second user's terminal 500-2 based on information on the second user, who is designated by the first user using the input unit 501, received from the input unit 501, as indicated by an arrow 523.

In the second user's terminal 500-2, a reception unit 514 receives the associated fortune request and the first output signal from the first user, informs the second user of the first user's request, and transmits the first output signal to an output unit 515 as indicated by an arrow 525.

The second user inputs a signal for a second output signal via an input unit 511. An output signal generator 512 receives the input signal, as indicated by an arrow 526, calculates the second output signal, and transmits the calculated second output signal to a transmission unit 513, as indicated by an arrow 527. The transmission unit 513 transmits the second output signal to a reception unit 504 of the first user's terminal 500-1, as indicated by an arrow 528.

Also, the output signal generator 512 transmits the generated second output signal to the output unit 515, as indicated by an arrow 529. The output unit 515 calculates a final output signal from the first and second output signals, searches a database 516 for the contents of a fortune corresponding to the final output signal, by using the final output signal, and retrieves the searched contents to display them to the second user.

In the first user's terminal 500-1, the reception unit 504 receives the second output signal transmitted from the second user's terminal 500-2, as indicated by the arrow 528, and transmits the second output signal to an output unit 505, as indicated by an arrow 532.

In the same manner as in the output unit 515 of the second user's terminal 500-2, the output unit 505 calculates a final output signal from the first output signal transmitted from the output signal generator 502, as indicated by an arrow 535, and the second output signal transmitted from the reception unit 504, as indicated by the arrow 532, and retrieves the contents of a fortune corresponding to the final output signal from a database 506 to display them to the first user.

Although the above embodiment has been described with reference to that only the second output signal is transmitted from the second user's terminal to the first user's terminal, it will be appreciated that the final output signal calculated in the second user's terminal or output data including the contents of a fortune retrieved based on the final output signal could be transmitted to the first user's terminal.

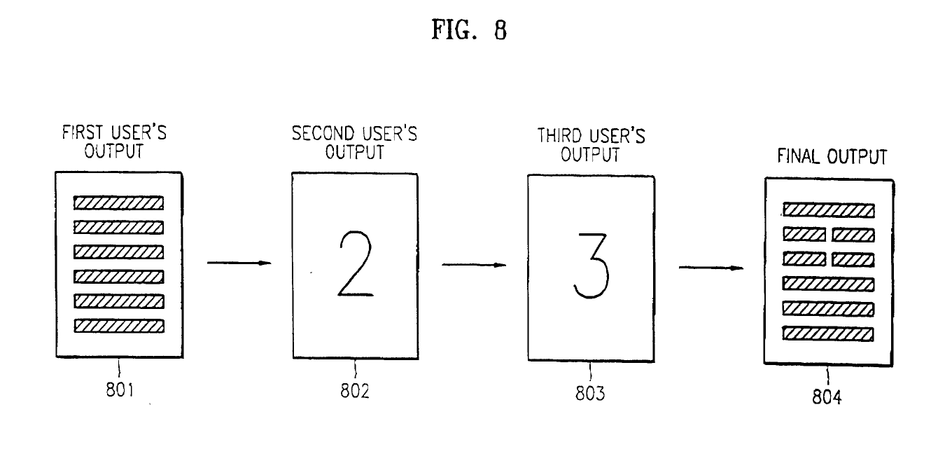

FIG. 6 is a flowchart illustrating a method for calculating an associated fortune for two or more users using the fortune provider server 201.

First, a first user accesses the fortune provider server 201 (Step 601) and logs into the fortune provider server 201 (not shown). The first user designates a second user as the other party for their associated fortune (Step 602). The second user may be one specified user, a number of specified users, or a number of unspecified users.

The second user may be designated in a variety of ways. For example, the second user may be designated using his/her ID used for registration with the fortune provider server 201. In this case, once a particular ID is designated for the second user, upon access of a user having the same ID as the designated ID, his/her associated fortune with the first user can be calculated using the output signal of the first user and an output signal of the second user accessed the fortune provider server 201 with the same ID. Alternatively, a password may be previously given to the second user via an e-mail, an instant messenger program, a SMS, etc., so that the second user is coupled with the first user for their associated fortune upon his/her access to the fortune provider server 201 with that password.

Alternatively, the first user may obtain his/her associated fortune with a number of unspecified users in a cyber space, such as a cyber chatting site. This example can be applied to a web site that mediates a blind date between a man and a woman. In this case, a man or a woman is allowed to predict his or her associated fortune in love with unspecified people prior to their offline or online meeting. This application is considered to be highly popular among clients.

When the second user accesses the fortune provider server 201 (Step 603), the first user inputs an input signal for a first output signal to be used to calculate their associated fortune (Step 604), and the second user inputs an input signal for a second output signal to be used to calculate their associated fortune (Step 605).

To allow the first and second users to input their input signals, a data input interface program needs to be basically installed in the first user's and second user's terminals. If the data input interface program is not installed in the first user's and second user's terminals, a step of downloading a data interface program from the fortune provider server 201 may be further included (not shown).

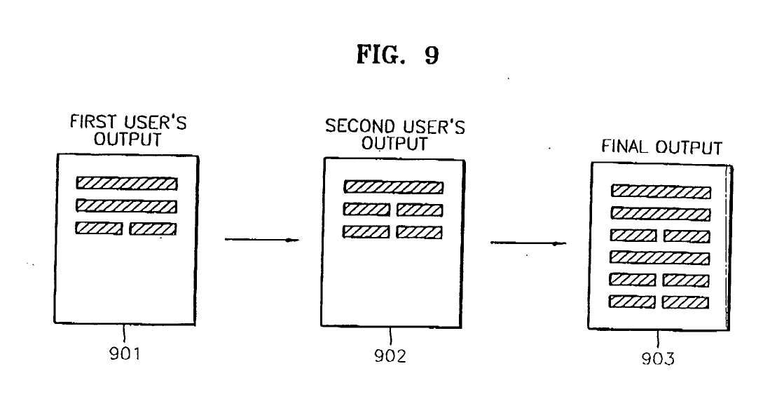

FIGS. 7 through 9 show examples of calculating a final output signal using a first output signal for the first user and a second output signal for the second user.

Referring to FIG. 7, a first output signal 701 for the first user consists of a series of lines sequentially indicating ‘Yang’ (continuous line), ‘Yang’, ‘Yang’, ‘Yin’ (discontinuous lines), ‘Yang’, and ‘Yin’. The first output signal 701 may be calculated by receiving input from the first user six times with two kinds of signals generated from the random number generator 302 or 404 of the output signal generator 301 or 403. Alternatively, the first output signal 701 may be calculated by receiving input from the first user only once with 64 kinds of signals generated from the random number generator 302 or 404. Alternatively, the first output signal 701 may be calculated by receiving input from the first user twice with 8 kinds of signals generated from the random number generator 302 or 404. The first output signal 701 can be calculated by a variety of methods without limitation to the above-listed methods.

A second output signal 702 for the second user is shown as a number “3”. The second output signal 702 for the second user is calculated using an input signal from the second user and arbitrary signals generated from the random number generator 302 or 304 of the output signal generator 301 or 403. The second output signal 702 for the second user can be calculated by a variety of methods. In the example shown in FIG. 7, the second output signal 702 has been calculated by receiving an input signal from the second user only once with 6 kinds of signals generated from the random number generator. The second output signal 702 may be displayed on a screen of the second user's terminal, as a number, as shown in FIG. 7, or as spots on a die.

After the first output signal 701 and the second output signal 702 have been calculated, a final output signal 703 is calculated from the first output signal 701 and the second output signal 702 (Step 606). The final output signal 703 shown in FIG. 7 is calculated by the following method.

In FIG. 7, the first output signal 701 is generated as a series of six lines, sequentially indicating ‘Yang’, ‘Yang’, ‘Yang’, ‘Yin’, ‘Yin’, ‘Yang’, and ‘Yin’, and the second output signal 702 is generated as a number “3”. Here, the number “3” of the second output signal 702 means to alter, e.g., to invert, the third signal component (corresponding to the third line) of the first output signal 701 to obtain a final output signal. As a result, a series of six lines, ‘Yang’, ‘Yang’, ‘Yin’, ‘Yin’, ‘Yang’, and ‘Yang’, which are obtained by inverting the third signal component of the first output signal 701, is obtained as the final output signal 703.

Although in the example of FIG. 7 only one of the signal components of the first output signal 701 has been inverted using the second output signal 702 to obtain the final output signal 703, more than one signal component of the first output signal 701 may be altered by receiving input from the second user several times. Alternatively, the first output signal 701 may be altered using a plurality of output signals, including the second output signal, a third output signal, a fourth output signal, etc., from different users.

FIG. 8 shows an example of calculating a final output signal for an associated fortune for three users. In FIG. 8, a first output signal 801 is generated as a series of six lines, sequentially indicating ‘Yang’, ‘Yang’, ‘Yang’, ‘Yang’, ‘Yang’, ‘Yang’, a second output signal 802 is generated as a number “2”, and a third output signal 803 is generated as a number “3”. In this example, the second and third signal components of the first output signal 801 are inverted to obtain a final output signal 804 expressed as six lines sequentially indicating ‘Yang’, ‘Yin’, ‘Yin’, ‘Yang’, ‘Yang’, ‘Yang’.

Although in the examples of FIGS. 7 and 8 some of the signal components of the first output signal have been altered using output signals, such as the second output signal, for other users, a final output signal may be obtained by combining the first output signal with other output signals.

FIG. 9 shows an example of calculating a final output signal 903 by combining a first output signal 901 with a second output signal 902. As shown in FIG. 9, the first output signal 901 is generated as three lines, sequentially indicating ‘Yang’, ‘Yang’, and ‘Yin’, by receiving input from the first user only three times, and the second output signal 902 is generated as three lines, sequentially indicating ‘Yang’, ‘Yin’, and ‘Yin’ by receiving input from the second user three times. The final output signal 903 is obtained by adding the second output signal 902 below the first output signal 901, to be six lines sequentially indicating ‘Yang’, ‘Yang’, ‘Yin’, ‘Yang’, ‘Yin’, and ‘Yin’.

Although in the examples described with reference to FIGS. 7 through 9 the calculation of a final output signal by altering some of the signal components of a first output signal generated to be equal in data size to the final output signal, using a second output signal, and the calculation of a final output signal by combining a first output signal generated to include some signal components of the final output signal with a second output signal have been introduced, the final output signal can be calculated by a variety of methods without limitation to those examples. For example, a final output signal constituted with 6 signal components expressed as 6 lines may be calculated by using a first output signal generated as only three lines each indicating ‘Yang’ or ‘Yin’ and a second output signal constituted with a signal component for inverting one of the three lines (components) of the first output signal and three signal components generated as three lines. Alternatively, the six lines constituting the final output signal may be generated alternately by the first and second users. Other methods for calculating a final output signal can be applied without departing from the spirit and scope of the invention.

Referring to FIG. 6, once the calculation of the final output signal is complete, the search unit 402 searches the database 401 for the content of a fortune corresponding to the final output signal to obtain output data including the searched content of the fortune (Step 607).

In the database 401 different fortunes for each of the 64 trigrams from the Book of Changes are stored for each category of fortune, for example, a fortune in love, a fortune in business, etc., to be retrieved according to a final output signal. The search unit 402 retrieves the contents of a fortune corresponding to the final output signal and obtains the output data including the retrieved contents. The output data are transmitted to each of the users' terminals through the transmission unit 406 to allow the users to check their associated fortune in a category of interest.

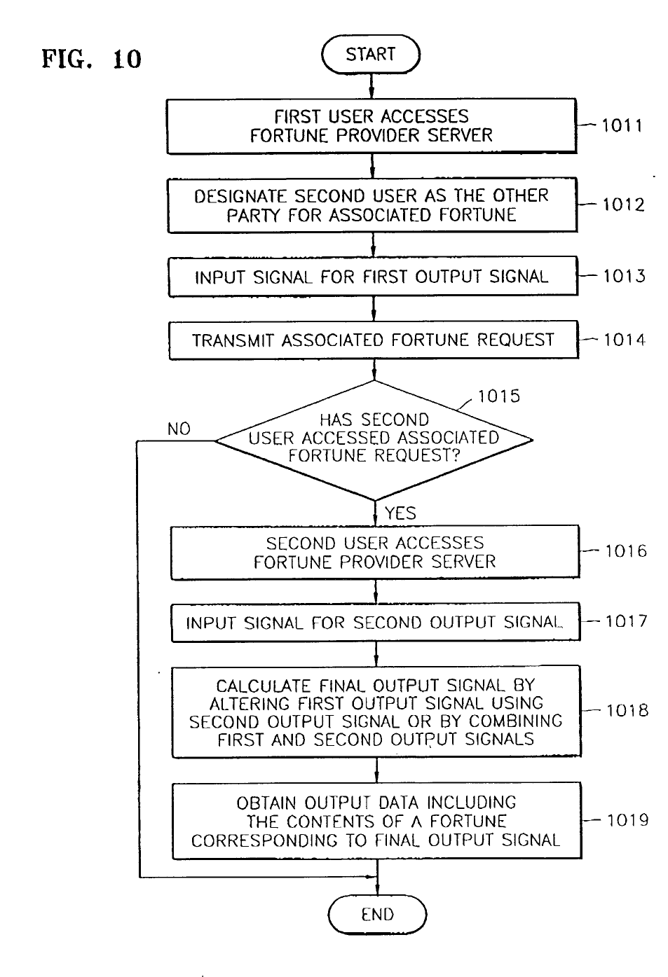

FIG. 10 is a flowchart illustrating another embodiment of the method for calculating an associated fortune for two or more users using a fortune provider server. Initially, a first user accesses the fortune provider server 201 (Step 1011). The first user designates a second user for their associated fortune (Step 1012) and provides input for a first output signal (Step 1013). The fortune provider server 201 transmits an associated fortune request from the first user to the second user using an e-mail address, a mobile phone number, an IP address, etc. input by the first user (Step 1014).

If the second user accepts the associated fortune request (Step 1015), the second user accesses the fortune provider server 201 (Step 1016) and provides input for a second output signal (Step 1017). The output signal generator 403 of the fortune provider server 201 calculates a final output signal from the first and second output signals, as described with reference to FIGS. 7 through 9 (Step 1018). Output data including the contents of a fortune retrieved from the database 401 according to the final output signal are obtained (Step 1019) and transmitted to both of the first and second users.

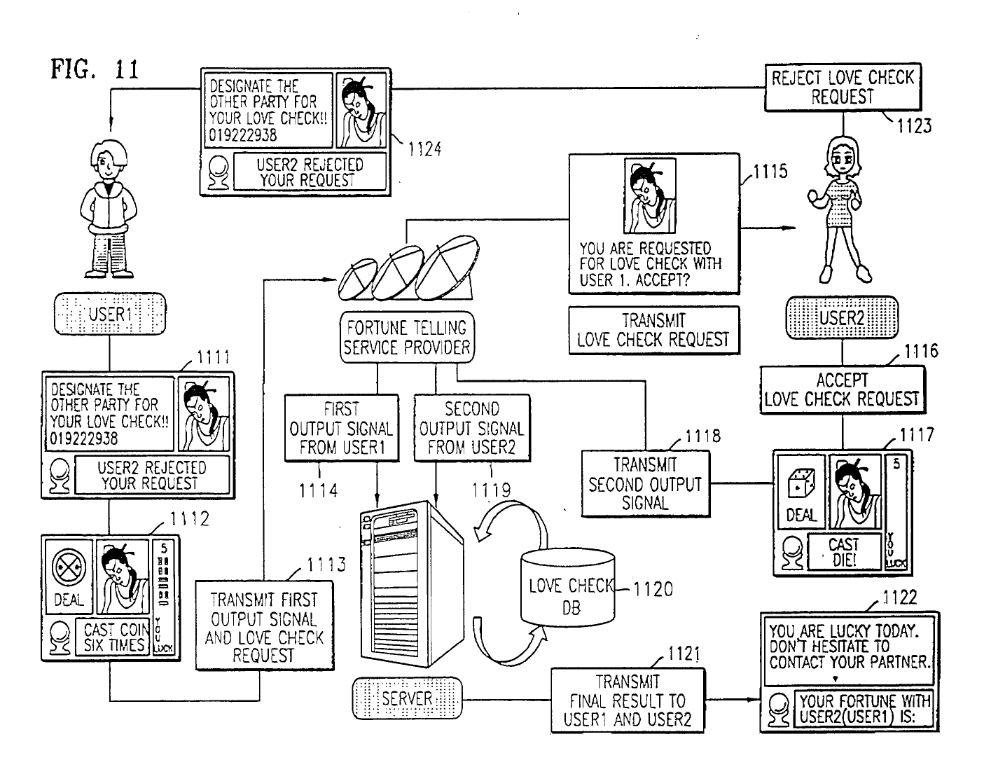

FIG. 11 shows a detailed embodiment of the method of FIG. 10 for calculating an associated fortune in love between two users. User 1 designate User 2 for their associated fortune in love by inputting the User 2's mobile phone number (Step 1111). User 1 provides input six times to obtain a first output signal (Step 1112). Immediately, the first output signal is displayed on the right of the screen. In FIG. 11, the first output signal is displayed as ‘Yin’, ‘Yin’, ‘Yang’, ‘Yang’, ‘Yin’, and ‘Yang’.

User 1 transmits the first output signal and an associated fortune request (in the present embodiment, “love check request”) to a fortune telling service provider (Step 1113). The fortune telling service provider stores the first output signal from User 1 in a fortune provider server (Step 1114) and transmits the associated fortune request to User 2 (Step 1115).

If User 2 rejects the associated fortune request (Step 1123), User 1 is informed of the rejection of the associated fortune request (Step 1124). If User 2 accepts the associated fortune request (Step 1116), User 2 is requested to provide input for a second output signal (Step 1117). In the embodiment of FIG. 11, a die is displayed to User 2, and one of the six sides of the die is chosen according to the input from User 2 as a second output signal. The obtained second output signal is transmitted to the fortune telling service provider (Step 1118).

The fortune telling service provider calculates a final output signal using the first output signal from User 1 and the second output signal from User 2, and searches a database (“love check DB”) 1120, which stores the contents of fortunes in love, for the contents of a fortune in love corresponding to the final output signal, calculates a final output data including the searched contents, and transmits the final output data to Users 1 and 2 (Step 1121).

Although User 1 and User 2 provide different inputs for their fortune in love, the same final output data 1122 is displayed on the terminals of User 1 and User 2, thereby increasing reliability of the result.

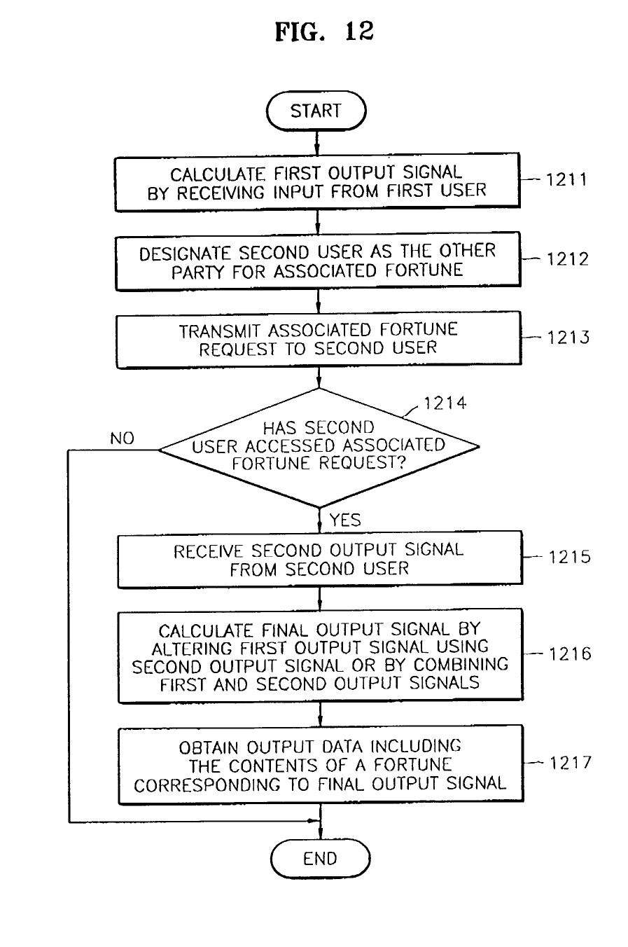

FIG. 12 is a flowchart illustrating an embodiment of the method for calculating an associated fortune for two or more users without using a fortune provider server. A first user provides input for a first output signal using his/her own terminal 500-1 of FIG. 5 (Step 1211) and designates a second user as the other party for their associated fortune (Step 1212). The second user may be designated in a variety of ways, for example, using an e-mail address, an IP address, a mobile phone number, etc.

Once the second user is designated, the first user transmits an associated fortune request to the second user (Step 1213). Although not illustrated in FIG. 12, a first output signal may be transmitted together with the associated fortune request.

If the second user accepts the associated fortune request from the first user (Step 1214), the second user is requested to provided input using his/her own terminal 500-2 of FIG. 5 to obtain a second output signal and to transmit the second output signal to the first user (Step 1215). Although not illustrated in FIG. 12, in the second user's terminal 500-2, a final output signal may be calculated using the second output signal and the first output signal received from the first user, as described with reference to FIGS. 7 through 9, and output data including the contents of a fortune corresponding to the final output signal may be shown to the first and second users.

Next, in the first user's terminal 500-1 to which the second output signal is transmitted from the second user, a final output signal is calculated using the first output signal and the second output signal, as described with reference to FIGS. 7 through 9 (Step 1216).

After the final output signal is calculated (Step 1216), the database 506 is searched for the contents of a fortune corresponding to the final output signal, and output data including the searched contents is shown to the first user (Step 1217).

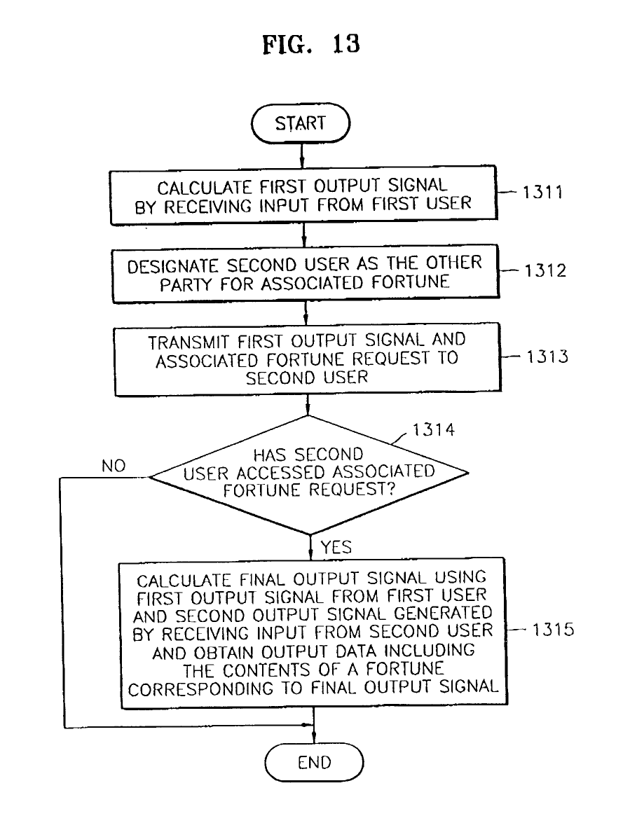

FIG. 13 is a flowchart illustrating another embodiment of the method for calculating an associated fortune for two or more users without using a fortune provider server.

This embodiment is similar to the embodiment described with reference to FIG. 12. In particular, a first user inputs an input signal using his/her own terminal 500-1 to obtain a first output signal (Step 1311) and designates a second user as the other party for their associated fortune (Step 1312). Next, an associated fortune request and the first output signal are transmitted to the second user (Step 1313).

If the second user accepts the associated fortune request from the first user (Step 1314), the second user is requested to provide input to obtain a second output signal. In the second user's terminal 500-2, a final output signal is calculated using the second output signal and the first output signal received from the first user, and output data including the contents of a fortune corresponding to the final output signal is shown to the second user and is transmitted to the first user (Step 1315). The first user's terminal receives the transmitted output data and shows it to the first user (not shown), thereby terminating the overall procedure.

The present invention may be embodied as a computer readable medium having a computer readable program code unit embodied therein for calculating one's fortune. The computer readable medium includes any types of storage media readable by a computer system. Examples of the computer readable medium include magnetic storage media (e.g., ROMs, RAMs, floppy discs, etc.), optically readable media (e.g., CD-ROMs, DVDs, etc.), and carrier waves (e.g., transmissions over the Internet). The computer readable medium may store therein a computer readable program code which can be transmitted to and operated in multiple computer systems connected by a network.

As described above, a method and system for calculating an associated fortune for two or more people according to the prevent invention attracts users, in view of the concept of the invention, compared to independently calculating each individual's fortune. The method and system according to the present invention can prevent a conflict between the results of the fortune calculation in a particular category of fortunes for each person, which would occur when an associated fortune for people is predicted based on the results of calculating each individual's fortunes as in conventional methods, thereby improving user's trust in fortune telling service providers.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method for calculating an associated fortune for two or more people, the method comprising:
calculating a primary output signal by receiving a primary input for the associated fortune at least one time from a primary user;
calculating a secondary output signal by receiving a secondary input at least one time from at least one secondary user as the other party for their associated fortune;
calculating a final output signal using the primary output signal and the secondary output signal; and
obtaining output data including the content of a fortune corresponding to the final output signal.

2. The method of claim 1, further comprising:
receiving the primary user's access;
receiving from the primary user the designation of the at least one secondary user as the other party for their associated fortune;
transmitting an associated fortune request to the at least one secondary user; and
receiving the at least one secondary user's access if the at least one secondary user has accepted the associated fortune request.

3. The method of claim 1, further comprising:
downloading an interface program for receiving the primary input from the primary user and for displaying the primary output signal to the primary user; and
downloading an interface program for receiving the secondary input from the secondary user and for displaying the secondary output signal to the secondary user.

4. A method for calculating an associated fortune for two or more people, the method comprising:
calculating a primary output signal by receiving a primary input for the associated fortune from a primary user;
receiving from the primary user the designation of at least one secondary user as the other party for their associated fortune;
transmitting an associated fortune request to the at least one secondary user;
receiving a secondary output signal calculated using a secondary input from the at least one secondary user;
calculating a final output signal using the primary output signal and the secondary output signal; and
obtaining output data including the contents of a fortune corresponding to the final output signal.

5. A method for calculating an associated fortune for two or more people, the method comprising:
calculating a primary output signal by receiving a primary input for the associated fortune from a primary user;
receiving from the primary user the designation of at least one secondary user as the other party for their associated fortune;
transmitting the primary output signal and an associated fortune request to the at least one secondary user; and
receiving from the at least one secondary user output data including the contents of a fortune corresponding to a final output signal calculated using the primary output signal and a secondary output signal calculated using a secondary input from the at least one secondary user.

6. The method of claim 1, wherein the secondary output signal is for partially or totally altering the primary output signal, and the final output signal is obtained by partially or totally altering the primary output signal using the secondary output signal.

7. The method of claim 4, wherein the secondary output signal is for partially or totally altering the primary output signal, and the final output signal is obtained by partially or totally altering the primary output signal using the secondary output signal.

8. The method of claim 5, wherein the secondary output signal is for partially or totally altering the primary output signal, and the final output signal is obtained by partially or totally altering the primary output signal using the secondary output signal.

9. The method of claim 1, wherein the primary output signal is a component signal of the final output signal, the secondary output signal is the other component signal of the final output signal.

10. The method of claim 4, wherein the primary output signal is a component signal of the final output signal, the secondary output signal is the other component signal of the final output signal.

11. The method of claim 5, wherein the primary output signal is a component signal of the final output signal, the secondary output signal is the other component signal of the final output signal.

12. The method of claim 1, wherein the primary output signal is a component signal of the final output signal, the secondary output signal is a combination signal of a signal for partially or totally altering the primary output signal and the other constituent signal of the final output signal, and the final output signal is obtained by combining the other constituent of the final output signal and the primary output signal that has been partially or totally altered using the secondary output signal.

13. The method of claim 4, wherein the primary output signal is a component signal of the final output signal, the secondary output signal is a combination signal of a signal for partially or totally altering the primary output signal and the other constituent signal of the final output signal, and the final output signal is obtained by combining the other constituent of the final output signal and the primary output signal that has been partially or totally altered using the secondary output signal.

14. The method of claim 5, wherein the primary output signal is a component signal of the final output signal, the secondary output signal is a combination signal of a signal for partially or totally altering the primary output signal and the other constituent signal of the final output signal, and the final output signal is obtained by combining the other constituent of the final output signal and the primary output signal that has been partially or totally altered using the secondary output signal.

15. The method of claim 1, wherein the final output signal corresponds to one of the 64 trigrams of the Book of Changes.

16. The method of claim 4, wherein the final output signal corresponds to one of the 64 trigrams of the Book of Changes.

17. The method of claim 5, wherein the final output signal corresponds to one of the 64 trigrams of the Book of Changes.

18. The method of claim 1, wherein the primary input from the primary user is provided once or six times to generate the primary output signal as a signal corresponding to one of the 64 trigrams of the Book of Changes.

19. The method of claim 4, wherein the primary input from the primary user is provided once or six times to generate the primary output signal as a signal corresponding to one of the 64 trigrams of the Book of Changes.

20. The method of claim 5, wherein the primary input from the primary user is provided once or six times to generate the primary output signal as a signal corresponding to one of the 64 trigrams of the Book of Changes.

21. A system for calculating an associated fortune for two or more people, the system comprising:
a first terminal including a first input unit which receives from a first user a first input for a first output signal and the designation of at least one second user as the other party for their associated fortune, a first transmission unit which transmits to a fortune provider server an associated fortune request to the designated at least one second user and the first input from the first user, and a first reception unit which receives the contents of a fortune from the fortune provider server;
a second terminal including a second input unit which receives from the at least one second user a second input for a second output signal, a second reception unit which receives the associated fortune request and the contents of a fortune from the fortune provider server, and a second transmission unit which transmits the second input from the second user, and
a server system including an output signal generator which calculates the first output signal from the first input and the second output signal from the second input and calculates a final output signal by altering the first output signal using the second output signal or by combining the first output signal with the second output signal, a database of a variety of fortunes from which the contents of a fortune corresponding to the final output signal is output, a search unit which searches the database for the contents of a fortune corresponding to the final output signal, and a third transmission unit which transmits the searched contents from the search unit to the first terminal and the second terminal.

22. A system for calculating an associated fortune for two or more people, the system comprising:
a first terminal including a first input unit which receives from a first user a first input for a first output signal and the designation of at least one second user as the other party for their associated fortune, a first output signal generator which generates a first output signal from the first input, a first transmission unit which transmits to a fortune provider server an associated fortune request to the designated at least one second user and the first output signal for the first user, and a first reception unit which receives the contents of a fortune from the fortune provider server;
a second terminal including a second input unit which receives from the at least one second user a second input for a second output signal, a second output signal generator which generates a second output signal from the second input, a second reception unit which receives the associated fortune request and the contents of a fortune from the fortune provider server, and a second transmission unit which transmits the second output signal for the second user, and
a server system including a final output signal generator which calculates a final output signal by altering the first output signal using the second output signal or by combining the first output signal with the second output signal, a database of a variety of fortunes from which the contents of a fortune corresponding to the final output signal is output, a search unit which searches the database for the contents of a fortune corresponding to the final output signal, and a third transmission unit which transmits the searched contents from the search unit to the first terminal and the second terminal.

23. A system for calculating an associated fortune for two or more people, the system comprising:
an input unit which receives from a first user input for an output signal and the designation of at least one second user as the other party for their associated fortune;
an output signal generator which generates a first output signal using the input from the input unit;
a first transmission unit which transmits a first associated fortune request to the at least one second user;
a first reception unit which receives a second output signal generated using input from the at least one second user;
a final output signal generator which generates a final output signal from the first output signal and the second output signal;
a database of a variety of fortunes from which the contents of a fortune corresponding to the final output signal is output; and
an output unit which outputs the contents of a fortune corresponding to the final output signal from the database.

24. The system of claim 23, further comprising:
a second transmission unit which transmits the first output signal from the output signal generator to the at least one second user; and
a second reception unit which receives a second associated fortune request from the at least one second user.

25. The system of claim 22, wherein the system is portable.

26. A system for calculating an associated fortune for two or more people, the system comprising:
a reception unit which receives input from at least two users who wish to obtain their associated fortune;
an output signal generator which generates an output signal using the input from the at least two users from the reception unit;
a database of a variety of fortunes from which the contents of a fortune corresponding to the final output signal is output;
a search unit which searches the database for the contents of a fortune corresponding to the output signal; and
a transmission unit which transmits the search contents from the search unit to the at least two users.

27. The system of claim 23, wherein the output signal generator comprises a random number generator which generates an arbitrary number within a predetermined range.

28. The system of claim 26, wherein the output signal generator comprises a random number generator which generates an arbitrary number within a predetermined range.

29. The system of claim 27, wherein the random number generator generates 2 kinds, 6 kinds, or 64 kinds of arbitrary signals.

30. The system of claim 28, wherein the random number generator generates 2 kinds, 6 kinds, or 64 kinds of arbitrary signals.

31. A computer readable medium having embodied thereon a computer program for the method for calculating an associated fortune for two or more peoples according to claim 1.

32. A computer readable medium having embodied thereon a computer program for the method for calculating an associated fortune for two or more peoples according to claim 4.

33. A computer readable medium having embodied thereon a computer program for the method for calculating an associated fortune for two or more peoples according to claim 5.
